(19) United States
(12) Patent Application Publication
(10) Pub. No.: US 2014/0007070 A1
(43) Pub. Date: Jan. 2, 2014

(54) Managing Software Product Lifecycle Across Multiple Operating System Platforms

(71) Applicants: Xing J. Huang, Shanghai (CN); Scott H. Isensee, Austin, TX (US); Sangeeta D. Kataria, Mumbai (IN); Sreejith Nalamvathukkal, Bangalore (IN); Anthony P. Papageorgiou, Southampton (GB); Marco Peise, Koeln (DE); Sajina Puthalath Kandy, Bangalore (IN); Renganathan Sundararaman, Cary, NC (US)

(72) Inventors: Xing J. Huang, Shanghai (CN); Scott H. Isensee, Austin, TX (US); Sangeeta D. Kataria, Mumbai (IN); Sreejith Nalamvathukkal, Bangalore (IN); Anthony P. Papageorgiou, Southampton (GB); Marco Peise, Koeln (DE); Sajina Puthalath Kandy, Bangalore (IN); Renganathan Sundararaman, Cary, NC (US)

(73) Assignee: International Business Machines Corporation, Armonk, NY (US)

(21) Appl. No.: 13/537,439

(22) Filed: Jun. 29, 2012

(51) Int. Cl. G06F 9/44

(52) U.S. Cl. 717/170

(57) ABSTRACT

A mechanism is provided for managing the life cycle of software products across multiple platforms. A software product framework is provided for integrating access to information and installation support regarding at least two different software products on at least two different operating system platforms. A first client device is registered for a first version of a software product and a second client device is registered for a second version of the software product of the at least two different software products, where the first version and the second version are not a same version. Responsive to receiving a third version of the software product, the first version is automatically updated to the third version of the software product on the first client device, while the second version is not automatically updated to the third version of the software product on the second client device.

### BACKGROUND

The present application relates generally to an improved data processing apparatus and method and more specifically to mechanisms for managing the lifecycle of software products across multiple operating system platforms.

Generally, software producing entities are faced with issues such as consumability, product awareness, and portfolio management when interacting with customers. In consumability, software products are obtained, installed, and upgraded in many different, often unintuitive, ways. This means customers are spending more and more time managing the purchased products than actually using them. Furthermore, spending more and more time managing the purchased products than actually using them not only makes customers dissatisfied with the product, but may also have a negative effect on the company brand itself. For example, a customer who spends most of their time maintaining a product will not be compelled to upgrade to the latest version for some ‘new features’ the customer does not have time to utilize. In extreme cases, customers migrate away from systems and software products that have turned into ‘pain points’ because of complex management procedures.

As to product awareness, the struggle for a software producing entity is to clearly articulate the features of a software products. That is, some software products are so highly complex that it may take an hour or more to explain just the basics of the software products. Thus, customers struggle to understand the value of some software offerings, which, if the customer does not clearly understand, the customer will not purchase what they do not understand. Also, if software products are seen to be difficult to obtain, install, and maintain, then the customer is unlikely to be compelled to try something different.

With regard to portfolio management, software producing companies not only expect customers to buy and maintain one product, but expect the customers to buy a number of products to build a ‘solution’. This can be a confusing and complex task for the software producing company and the customer, if it is difficult to convey and understand what each software product's role is and what options are available to form a solution. This in itself can be enough to put customers off from buying from the software producing company and steer the customer to a simpler solutions.

### SUMMARY

In one illustrative embodiment, a method, in a data processing system, is provided for managing the life cycle of software products across multiple platforms. The illustrative embodiment provides a software product framework for integrating access to information and installation support regarding at least two different software products on at least two different operating system platforms. The illustrative embodiment registers a first client device for a first version of a software product of the at least two different software products. The illustrative embodiment registers a second client device for a second version of the software product of the at least two different software products. In the illustrative embodiment, the first version and the second version are not a same version. Responsive to receiving a third version of the software product, the illustrative embodiment automatically updates the first version to the third version of the software product of the at least two different software products on the first client device and the illustrative embodiment does not automatically update the second version to the third version of the software product of the at least two different software products on the second client device.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a block diagram of a global software marketplace mechanism in accordance with the illustrative embodiments;

FIG. 4 depicts a flow diagram of the operation performed by console logic within a global software marketplace mechanism in either a server system or a client system in accordance with an illustrative embodiment;

FIG. 5 depicts a flow diagram of the operation performed by catalog viewing logic and/or access management logic within a global software marketplace mechanism in either a server system or a client system in accordance with an illustrative embodiment;

FIG. 6 depicts a flow diagram of the operation performed by product analysis logic within a global software marketplace mechanism in either a server system or a client system in accordance with an illustrative embodiment;

FIG. 7 depicts a flow diagram of the operation performed by compatibility logic within a global software marketplace mechanism in either a server system or a client system in accordance with an illustrative embodiment;

FIG. 8 depicts a flow diagram of the operation performed by download management logic within a global software marketplace mechanism in either a server system or a client system in accordance with an illustrative embodiment;

FIG. 9 depicts a flow diagram of the operation performed by installation management logic within a global software marketplace mechanism in either a server system or a client system in accordance with an illustrative embodiment;

FIG. 10 depicts a flow diagram of the operation performed by upgrade management logic within a global software marketplace mechanism in either a server system or a client system in accordance with an illustrative embodiment; and

FIG. 11 depicts a flow diagram of the operation performed by access requisition logic within a global software marketplace mechanism in either a server system or a client system in accordance with an illustrative embodiment.

### DETAILED DESCRIPTION

The illustrative embodiments provide a solution that unifies the install and upgrade of software products across all software brands and operating system platforms to make consuming software products simple. The simplicity of the illustrative embodiments allow the customer to spend less time managing the software and more time utilizing the software product to build their business. The illustrative embodiments provide a framework called Global Software Marketplace. The new framework addresses issues such as consumability, product awareness, and portfolio management when interacting with customers, thereby allowing customers to use and manage software products with ease. The framework described in the illustrative embodiments controls deployment of multiple software bundles to multiple devices across multiple operating system platforms.

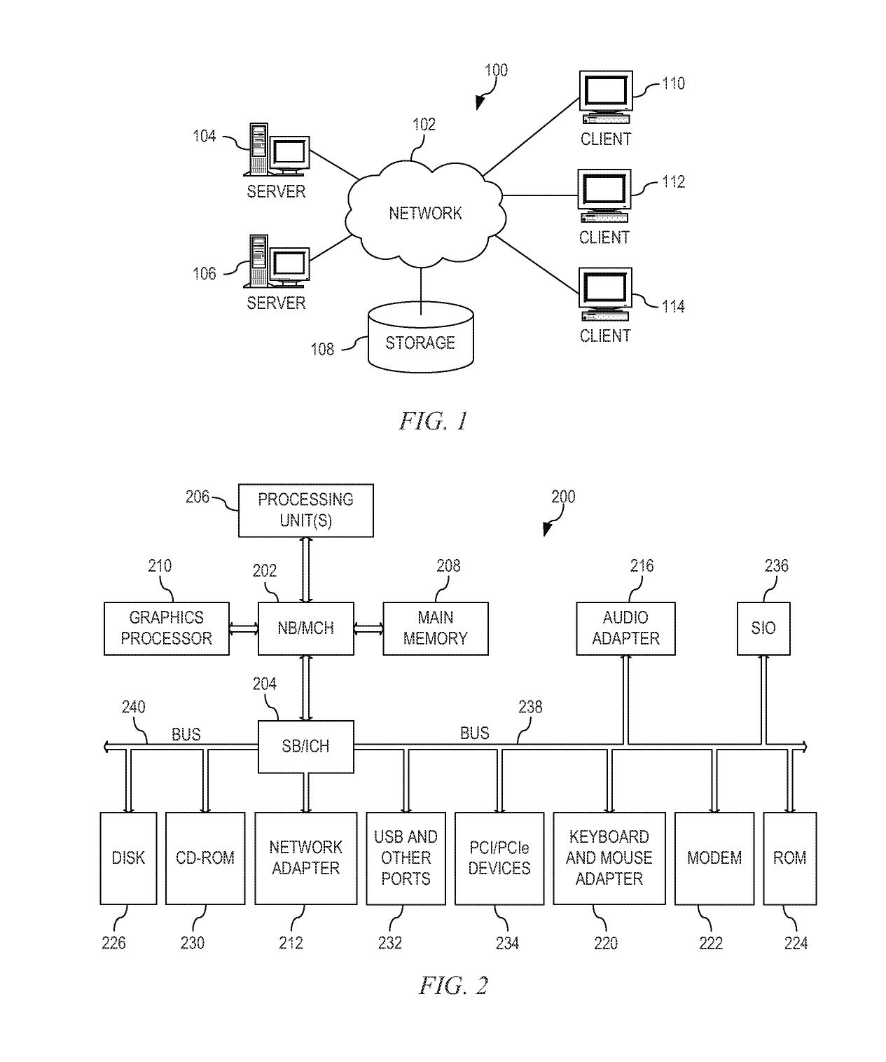

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows® 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD) 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

In order to provide a solution that unifies the install and upgrade of software products across all software brands and operating system platforms to make consuming software products simple, the illustrative embodiments provide for the installation and upgrade of software products through one unified interface across all platforms. The illustrative embodiments provide notifications of software updates, hot fixes, and new versions regardless of the company that provides the software, A customer may search for software products by brand, industry, category or the like, regardless of the operating system platform that the customer is currently utilizing. Once a product is found, the customer may review product details page, product reviews, product videos, demos/trial versions, or the like. The customer is also provided with recommended software products that are often used with the current software product based on what the software provider suggests, what other customers have installed, or the like. The customer is also provided with offers of pre-packaged solutions containing multiple pre-configured products based on the product they are currently reviewing. Additionally, if a customer is already using a particular software product and the illustrative embodiments recognize that the customer is entitled to another software product based on the currently utilized software product, then the illustrative embodiments provide the customer with a list of entitled software products. Further, the illustrative embodiments provide trial versions, demos, or the like to non-entitled customers. Still further, the system may be available as an administrator based system, a cloud based system, a stand-alone or client-based system, or any other currently known or further envisioned system.

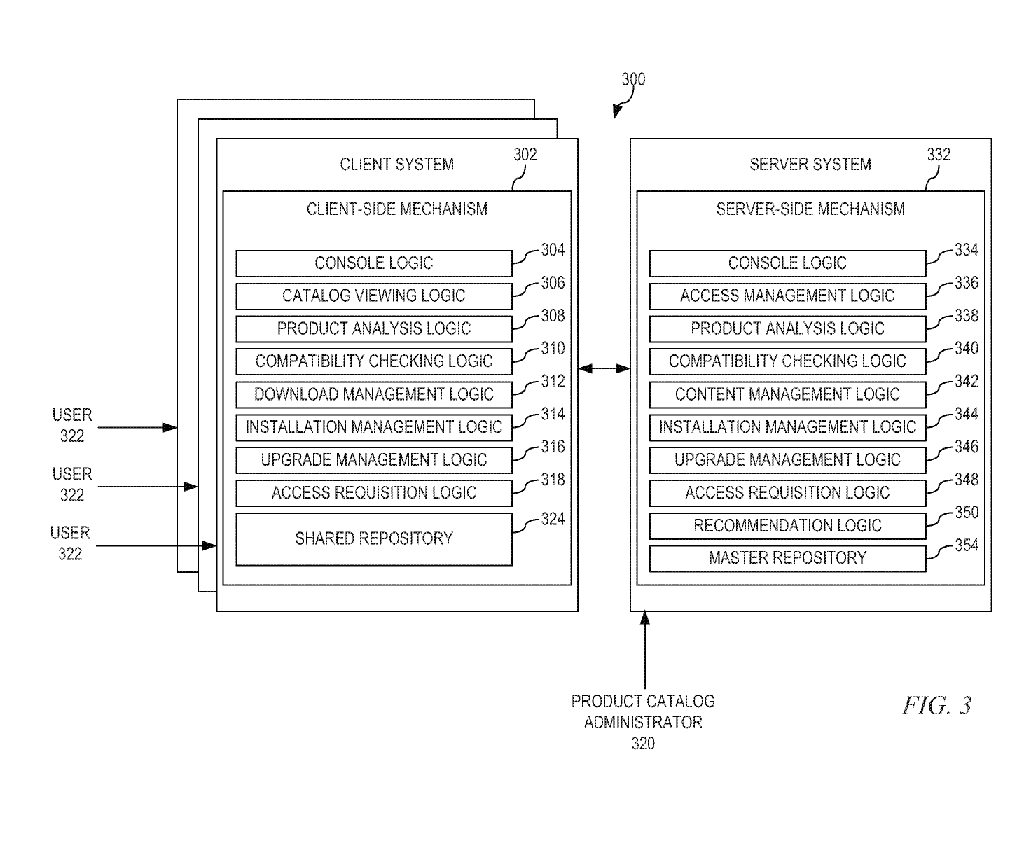

FIG. 3 depicts a block diagram of a global software marketplace mechanism in accordance with the illustrative embodiments. Global software marketplace mechanism 300 comprises client-side mechanism 302 and/or server-side mechanism 332. Client-side mechanism 302 comprises console logic 304, catalog viewing logic 306, product analysis logic 308, compatibility checking logic 310, download management logic 312, installation management logic 314, upgrade management logic 316, and access requisition logic 318. Client-side mechanism 302 is accessible by user 322, if the user has proper privileges. Further, user 322 may be able to access client-side mechanism 302 but may be limited in the actions that may be executed with client-side mechanism 302 based on privileges associated with user 322.

When accessing client-side mechanism 302, console logic 304 presents user 322 with access to catalog information pertaining to software products installed on the client system, a repository of the software installed on the client system, recommendations as to software related to the software installed on the client system based on what the software provider suggests, what other customers have installed, or the like, as well as a list of downloads for software purchased for the client system, and/or upgrades for the software installed on the client system. Catalog viewing logic 306 provides user 322 with access to view detailed information with regard to the software installed on the client system as well as detailed information with regard to searched software products. When user 322 searches an Internet, an Intranet, server-side mechanism 332, or the like, for software products using a keyword search, a phrase search, or the like, catalog viewing logic 306 provides user 322 with a list of products associated with the search regardless of operating system of the client system. Catalog viewing logic 306 provides user 322 with access to filter the returned information by brand, industry, solution, operating system, or the like. In accordance with the illustrative embodiments, the term “brand” relates to the software product entity that creates and/or markets the software product, such as Tivoli®, Websphere®, IBM®, Microsoft®, Apple®, or the like, the term “industry” relates to a business initiative, such as finance, healthcare, transportation, or the like, the term “solution” refers to services that can assist the customer in growing their business, such as business analytics, cloud services business process management, or the like, and the term “operating systems” refers to the operating system of the client system, such as Windows®, Unix®, Linux®, or the like. Catalog viewing logic 306 further provides user 322 with the ability to view details associated with each presented software product, which may be retrieved from shared repository 324 and or from the entity that provides the software product. Based on the searched-for product, catalog viewing logic 306 may also provide additional information with regard to featured software products, packaged solutions that include the searched-for software product, software products that other customers are currently looking at, popularity with regard to the sale of the software product, and/or ratings given by others who have purchased the particular software product. This information may be provided to user 322 in a same screen that the search results are presented or on a different screen. Finally, if user 322 choose to install a particular software product, catalog viewing logic 306 provides user 322 with the ability to install the selected software product.

Product analysis logic 308 analyzes and records all of the software products installed on the client system. Upon installation of global software marketplace mechanism 300, product analysis logic 308 performs a discovery of all software installed on the client system, which product analysis logic 308 stores as a list of installed software products in shared repository 324. Product analysis logic 308 also provides user 322 with the capability of reviewing configuration settings associated with each installed software product. Additionally, as user 322 install new software products or update existing software products, product analysis logic 308 adds to or updates the list of installed software products. Further, when user 322 wishes to view the list of installed software products, console logic 304 presents the list of installed software products to user 322 utilizing product analysis logic 308.

When user 322 chooses to install a particular software product via catalog viewing logic 306, compatibility checking logic 310 checks the compatibility of the selected software product to the operating system operating on the client system as well as, if requested, to other software products already installed on the client system. That is, not only is it important for compatibility checking logic 310 to verify whether the selected software product can operate correctly with the operating system of the client system, compatibility checking logic 310 also verifies whether the selected software product can operate within the configuration setting required for other software products installed on the client system.

If compatibility checking logic 310 verifies that the selected software product is compatible with the operating system operating on the client system and/or other software products already installed on the client system, then download management logic 312 begins a download of the selected software product. User 322 may view the progress of the operation being performed by download management logic 312 in downloading the selected software product as well as being able to view the status of other selected software products being downloaded. Utilizing download management logic 312, user 322 may be able to start a download if download management logic 312 has not been set up to automatically start the download process, suspend the download of a software product, resume the download of a software product that has been suspended, and view the results of the downloading of the software product.

Once the selected software product has been successfully downloaded, depending on preferences set by user 322, installation management logic 314 may either automatically, or upon receiving an indication from user 322, start the installation of the selected software product. User 322 may view the progress of the operation being performed by installation management logic 314 in installing the selected software product as well as being able to view the status of other selected software products being installed. Responsive to a completion of the installation of the selected software product, user 322 may be able to view the results of the installation of the software product as well as the settings associated with the software product.

Based on the software products installed on the client system, upgrade management logic 316 searches the software producing entities software download location to detect differences between each currently installed software product version and the software product version currently residing on the software producing entities software download location. That is, as software producing entities improve their software products, the software producing entities provide updates, which are made available to customers who have already purchased the software product. Therefore, upgrade management logic 316 detects the updates and provides an indication of the upgrade to user 322. Responsive to receiving an indication from user 322, upgrade management logic 316 may request download management logic 312 and installation management logic 314 to install the update in a similar manner to that described previously in relation to downloading and installing newly selected software products.

In addition to all of the features provided by client-side mechanism 302 as detailed above, access requisition logic 318 also provides user 322 with a list of entitled software products. That is, if the client system already comprises a particular software product, user 322 may be entitled to another software product based on the currently utilized software product. Access requisition logic 318 identifies these products from the software producing entities and provides user 322 with the list of entitled software products. Further, for non-entitled customers, access requisition logic 318 may identify software products indicated being used by other customers who utilize a same software product currently installed on the client system. If access requisition logic 318 identifies one or more such software products, the access requisition logic 318 provides user 322 of an indication of trial versions, demos, or the like.

As illustrated above, user 322 may utilize client-side mechanism 302 to install and upgrade all software products regardless of the software producing entity in one way. While the above scenario is depicted in a manner where client-side mechanism 302 has complete access to the Internet, client-side mechanism 302 may be hardened for a production environment. In such cases, the different product catalogs, software product downloads, software product updates, related software products, and the like, may be accessed via shared repository 324, which is updated by an authorized system or individual so that user 322 does not put the client-side mechanism 302 at risk. Further, the illustrative embodiment may operate such that no client-side mechanism 302 resides on the client system and all actions described above are administered via arm authorized system, when user interaction is not warranted.

Such an authorized system may be server-side mechanism 332. Server-side mechanism 332 comprises console logic 334, access management logic 336, product analysis logic 338, compatibility checking logic 340, content management logic 342, installation management logic 344, upgrade management logic 346, access requisition logic 348, and recommendation logic 350. Client-side mechanism 302 is accessible by product catalog administrator 320 and provides product catalog administrator 320 with the capability to provide information to one or more client-side mechanisms 302 and well as the ability to perform installation and upgrades of software products to client-side mechanisms 302 regardless of the operating system of the server system or the client systems.

When accessing server-side mechanism 332, console logic 334 provides product catalog administrator 320 with the ability to access to catalog information pertaining to software products installed on the server system and one or more client systems accessible via the server system, a repository of the all software installed on the server system and all client systems, as well as a list of downloads for software purchased for the server system and all client systems and/or upgrades for the software installed on the server system and all client systems. Console logic 336 also provides for the administration of master repository 354 of all software images installed on the one or more client systems as well as the server system.

Access management logic 336 provides product catalog administrator 320 with access to view and provide detailed information with regard to the software installed on the server system and all client systems as well as detailed information with regard to searched-for software products. When user 322 sends a search request or product catalog administrator 320 submits a search request, access management logic 336 searches an Internet, an Intranet, or the like, for software products using a keyword search, a phrase search, or the like. Access management logic 336 provides product catalog administrator 320 and/or user 322 with a list of products associated with the search regardless of the operating system of the server system or client system. Similar to catalog viewing logic 306 described above, access management logic 336 provides product catalog administrator 320 with access to filter the returned information by brand, industry, solution, operating system, or the like. Access management logic 336 further provides product catalog administrator 320 with the ability to view details associated with each presented software product, which may be retrieved from master repository 354 and/or from the entity that provides the software product. Based on the searched-for product, access management logic 336 may utilize recommendation logic 350 to identify additional information with regard to featured software products, packaged solutions that include the searched-for software product, software products that other customers are currently looking at, popularity with regard to the sale of the software product, and/or ratings given by others who have purchased the particular software product. This, information may be provided to product catalog administrator 320 in a same screen that the search results are presented or on a different screen and/or to upgrade management logic 316 in client-side mechanisms 302 so the information may be presented to product catalog administrator 320 and/or user 322 of the client system. Finally, if product catalog administrator 320 chooses to install a particular software product, access management logic 336 provides product catalog administrator 320 with the ability to install the selected software product either on the sever system itself or on one or more of the client systems.

Product analysis logic 338 analyzes and records all of the software products installed on the server system and all of the one or more client systems. Upon installation of global software marketplace mechanism 300, product analysis logic 338 performs a discovery of all software installed on the server system and all of the one or more client systems, which product analysis logic 338 stores as a list of installed software products in master repository 354 identified by the system to which the particular software product is installed. Product analysis logic 338 also provides product catalog administrator 320 with the capability of reviewing configuration settings associated with each installed software product on the server system and all of the one or more client systems. Additionally, as product catalog administrator 320 installs new software products or updates existing software products, product analysis logic 338 adds to or updates the list of installed software products in master repository 354. Further, when product catalog administrator 320 wishes to view the list of installed software products on the server system or a particular one of the one or more client systems, console logic 334 presents the list of installed software products to product catalog administrator 320 utilizing product analysis logic 338.

When product catalog administrator 320 chooses to install a particular software product via access management logic 336 either on the server system or one or more of the client systems, compatibility checking logic 340 checks the compatibility of the selected software product to the operating system operating on the client system as well as, if requested, to other software products already installed on the client system. That is, not only is it important for compatibility checking logic 340 to verify whether the selected software product can operate correctly with the operating system of the server system or one or more of the client systems, compatibility checking logic 340 also verifies whether the selected software product can operate within the configuration setting required for other software products installed on the server system or one or more of the client systems.

If compatibility checking logic 340 verifies that the selected software product is compatible with the operating system operating on the server system or one or more of the client systems and/or other software products already installed on the server system or one or more of the client systems, content management logic 342 may either initiate, based on a request received from one or more client-side mechanisms 302, a download of the selected software product from master repository 354 if the software product image is stored in master repository 354 or retrieve the software image from the entity that provides the software product. Content management logic 342 may then store the software product image in master repository 354 and then initiate the download of the selected software product from master repository 354. Product catalog administrator 320 may view the progress of the operation being performed by content management logic 342 in downloading the selected software product as well as being able to view the status of other selected software products being downloaded.

For software being installed on or by the server system, installation management logic 344 may either automatically, or upon receiving an indication from product catalog administrator 320, start the installation of the selected software product on the server system or one or more of the client systems. Product catalog administrator 320 may view the progress of the operation being performed by installation management logic 344 in installing the selected software product as well as being able to view the status of other selected software products being installed. Responsive to a completion of the installation of the selected software product, product catalog administrator 320 may be able to view the results of the installation of the software product as well as the settings associated with the software product.

Based on the software products installed on the server system or one or more of the client systems, upgrade management logic 346 searches the software producing entities software download location to detect differences between each currently installed software product version and the software product version currently residing on the software producing entities software download location. That is, as software producing entities improve their software products, the software producing entities provide updates, which are made available to customer who have already purchased the software product. Therefore, upgrade management logic 346 detects the updates and provides an indication of the upgrade to product catalog administrator 320. Responsive to receiving an indication from product catalog administrator 320, upgrade management logic 346 may download the latest version of each software product where a new software product version exists into master repository 354. Upgrade management logic 346 may then identify those systems, whether server or client that require a software update. At this point, product catalog administrator 320 may select one or more of the systems for which the update is necessary and one or more of the system for which the update is optional. This decision may be made based upon preferences set by each user 322 associated with each client system, a recognition by product catalog administrator 320 that the update is not a so-called “important,” “critical,” or the like update, or some other recognized indication that the update should not or is not necessary to perform immediately. If an update is needed or necessary, then upgrade management logic 346 may either utilize download management logic 312 and installation management logic 314 in client-side mechanisms 302 to install the update or utilize installation management logic 344 to install the updates for the identified software product via server-side mechanism 332.

In addition to all of the features provided by server-side mechanism 332 as detailed above, access requisition logic 348 also provides client-side mechanisms 302 with a list of entitled software products. That is, if the client system already comprises a particular software product, the client system may be entitled to another software product based on the currently utilized software product. Access requisition logic 348 identifies these products from the software producing entities and a list of these products to access requisition logic 318 in client-side mechanisms 302. Further, for non-entitled customers, access requisition logic 348 may identify software products indicated being used by other customers who utilize a same software product currently installed on the client systems. If access requisition logic 348 identifies one or more such software products, the access requisition logic 348 provides product catalog administrator 320 of an indication of trial versions, demos, or the like, which may be passed on to access requisition logic 318 in client-side mechanisms 302. Further for both entitled and non-entitled customers, access requisition logic 348 may provide product catalog administrator 320 with the list of the products.

Therefore, global software marketplace mechanism 300 provides server-side mechanism 332 that may or may not be utilized in conjunction with client-side mechanisms 302 depending on implementation in order to install and upgrade all software products regardless of the software producing entity in one way.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

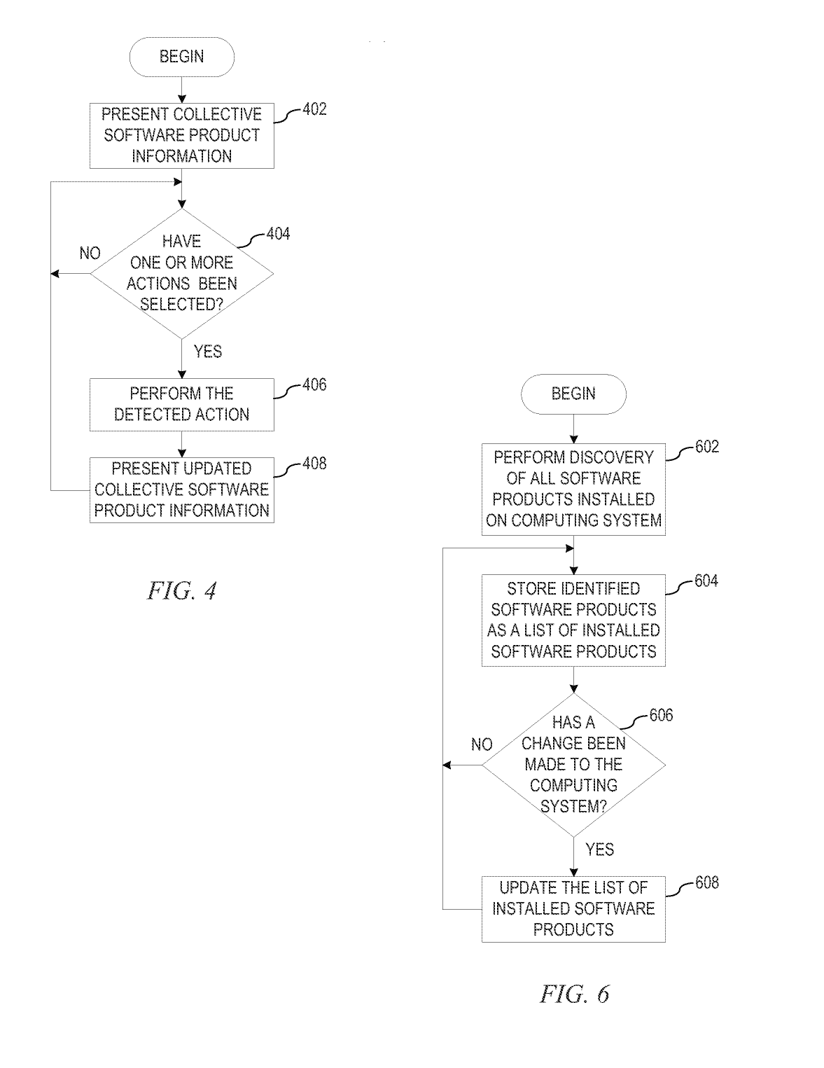

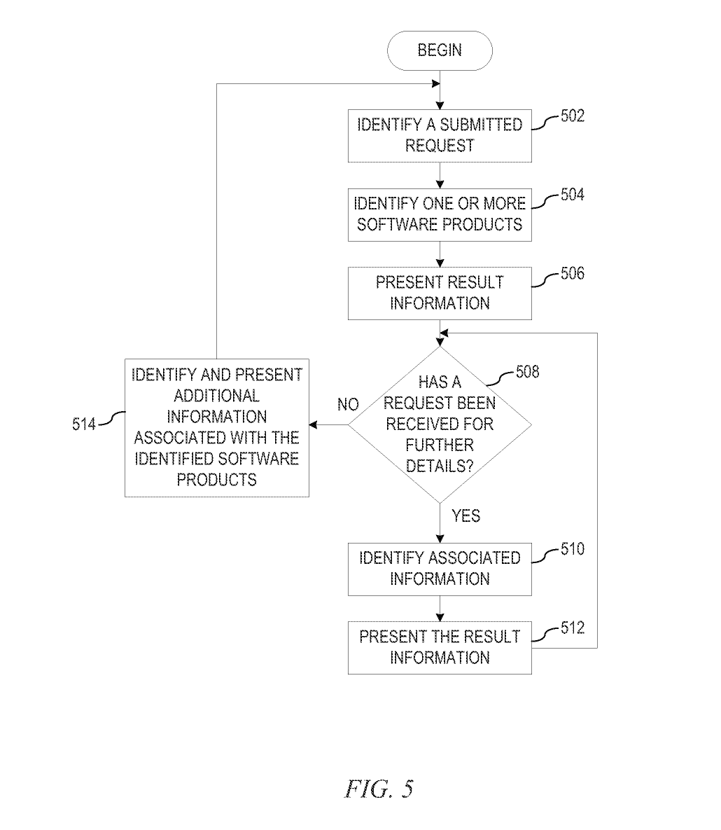

FIG. 4 depicts a flow diagram of the operation performed by console logic within a global software marketplace mechanism in either a server system or a client system in accordance with an illustrative embodiment. As the operation begins, an administrator and/or a user accesses a global software marketplace mechanism, the global software marketplace mechanism, executed by a processor, presents collective software product information to the administrator and/or user that comprises software products installed on one or more of a server system, a client system, or the like (step 402). The collective information may comprise catalog information pertaining to software products installed on the client system, a repository of the software installed on the client system, recommendations as to software related to the software installed on the client system based on what the software provider suggests, what other customers have installed, or the like, as well as a list of downloads for software purchased for the client system, and/or upgrades for the software installed on the client system. The global software marketplace mechanism then determines whether one or more actions have been selected by the administrator and/or user (step 404). These actions are further defined in FIGS. 5-11 which follow. If at step 404 the global software marketplace mechanism fails to detect a selected action, the operation returns to step 404. If at step 404, the global software marketplace mechanism detects a selected action, the global software marketplace mechanism performs the detected action (step 406) and, responsive to the completion of the selected action, the global software marketplace mechanism presents updated collective software product information to the administrator and/or user (step 408), with the process returning to step 404 thereafter.

FIG. 5 depicts a flow diagram of the operation performed by catalog viewing logic and/or access management logic within a global software marketplace mechanism in either a server system or a client system in accordance with an illustrative embodiment. As the operation begins, the global software marketplace mechanism, executed by a processor, identifies a request submitted by an administrator and/or user for information pertaining to software products using a keyword search, a phrase search, or the like (step 502). Responsive to receiving the request, the global software marketplace mechanism identifies one or more software products from the Internet, Intranet, and/or a repository regardless of the operating system of the system from which the request was received (step 504). The global software marketplace mechanism then presents result information to the user based on the identified software products (step 506). The global software marketplace mechanism then determines whether a request is received to view further details with regard to one of the identified software products (step 508). If at step 508 the global software marketplace mechanism receives a request to view details associated with an identified software product, the global software marketplace mechanism identifies associated information, such as product catalog, specification list, or the like, from the Internet, Intranet, and/or a repository (step 510). The global software marketplace mechanism then presents the result information to the user (step 512), with the operation returning to step 508 thereafter. If at step 508 the global software marketplace mechanism fails to receive a details request, the global software marketplace mechanism may identify and present additional information associated with the identified software products to the user (step 514), with the operation returning to step 502 thereafter. The additional information may comprise information with regard to featured software products, packaged solutions that include the searched-for software product, software products that other customers are currently looking at, popularity with regard to the sale of the software product, and/or ratings given by others who have purchased the particular software product.

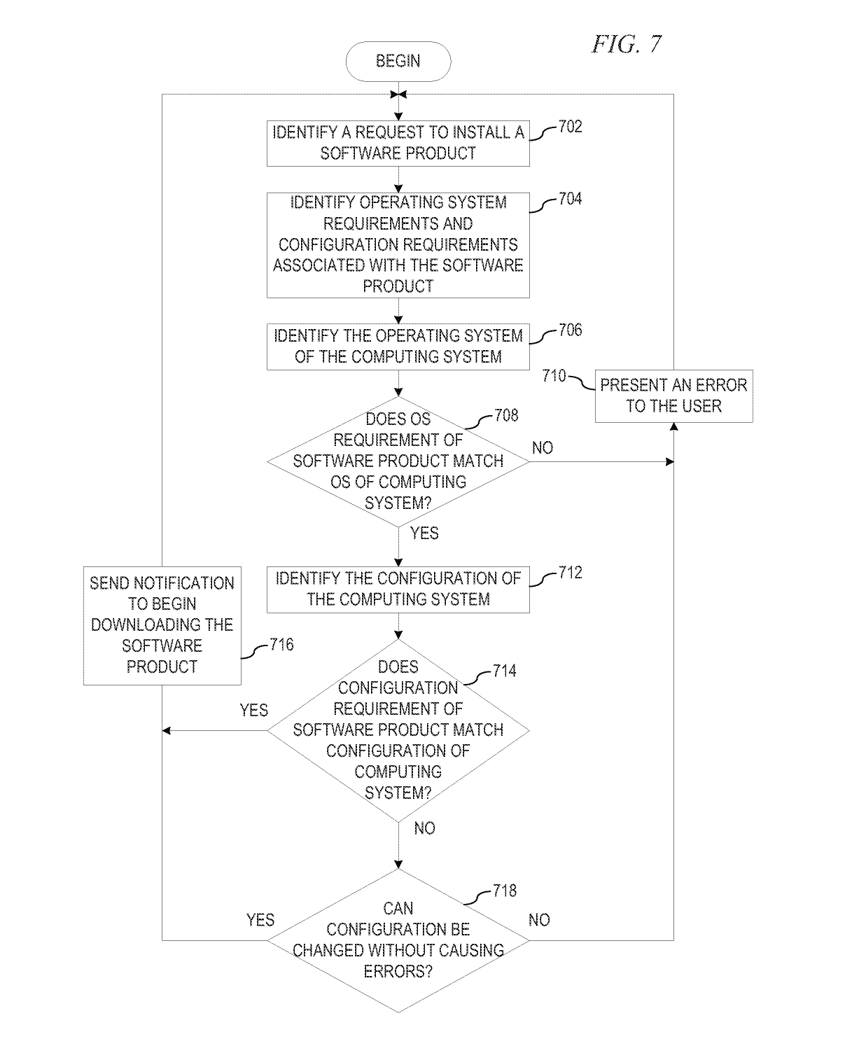

FIG. 6 depicts a flow diagram of the operation performed by product analysis logic within a global software marketplace mechanism in either a server system or a client system in accordance with an illustrative embodiment. As the operation begins, the global software marketplace mechanism, executed by a processor, performs a discovery of all software products installed on an identified computing system (step 602). The global software marketplace mechanism stores the identified software products as a list of installed software products in a repository (step 604). The global software marketplace mechanism then determines whether a change is made to the computing system by way of a new software product being installed, a software product being updated, or a software product being deleted (step 606). If at step 606 the global software marketplace mechanism determines a change has occurred, then global software marketplace mechanism updates the list of installed software products for that computing system (step 608). If at step 606 a list of installed software products fails to identify a change, then the operation returns to step 604.

FIG. 7 depicts a flow diagram of the operation performed by compatibility logic within a global software marketplace mechanism in either a server system or a client system in accordance with an illustrative embodiment. As the operation begins, the global software marketplace mechanism, executed by a processor, identifies a request to install a software product on a computing system (step 702). Upon receiving the request, the global software marketplace mechanism identifies operating system requirements and configuration requirements associated with the software product (step 704). The global software marketplace mechanism then identifies the operating system of the computing system (step 706). The global software marketplace mechanism then determines whether the operating system requirement of the software product matches the operating system of the computing system (step 708). If at step 708 the operating system requirement of the software product fails to match the operating system of the computing system, the global software marketplace mechanism presents an error to the user of the computing system (step 710), with the operation returning to step 702 thereafter. If at step 708 the operating system requirement of the software product matches the operating system of the computing system, then the global software marketplace mechanism identifies the configuration of the computing system (step 712). The global software marketplace mechanism then determines whether the configuration requirement of the software product matches the configuration of the computing system (step 714). If at step 714 the configuration requirements of the software product match the configuration of the computing system, then the global software marketplace mechanism sends a notification to download logic to begin downloading the software product (step 716), with the operating returning to step 702. If at step 714 the configuration requirements of the software product fail to match the configuration of the computing system, then global software marketplace mechanism determines whether the configuration of the computing system may be modified so as to support the software product without causing an error in an already installed software product (step 718). If at step 718 the global software marketplace mechanism determines that the configuration may be modified without causing an error in an already installed software product, then the operation proceeds to step 716. If at step 718 the global software marketplace mechanism determines that the configuration may not be modified without causing an error in an already installed software product, then the operation proceeds to step 710.

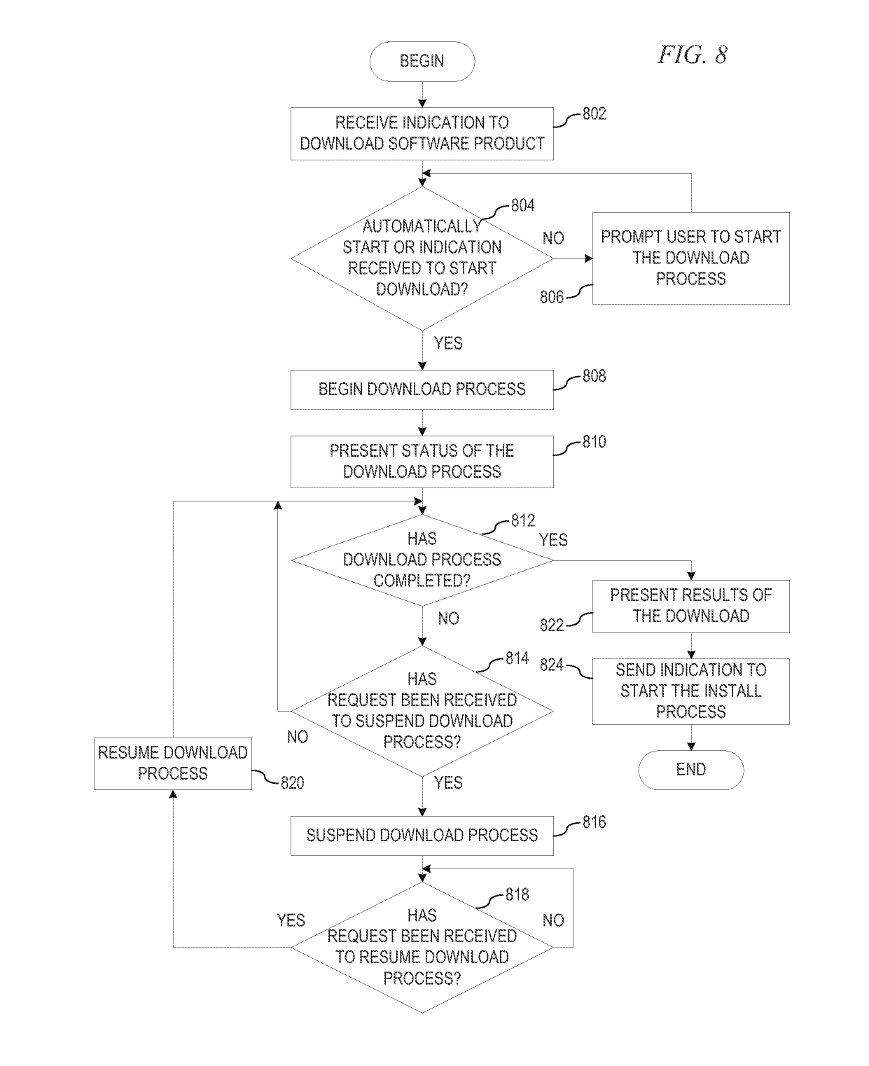

FIG. 8 depicts a flow diagram of the operation performed by download management logic within a global software marketplace mechanism in either a server system or a client system in accordance with an illustrative embodiment. As the operation begins, the global software marketplace mechanism, executed by a processor, receives an indication to download a software product (step 802). The global software marketplace mechanism determines whether a preference has been set to automatically start the download or an indication has been received to start the download (step 804). If at step 804 no preference is set to automatically start the download or an indication has not been received to start the download, then global software marketplace mechanism prompts the user to start the download process (step 806), with the process returning to step 804 thereafter. If at step 804 a preference is set to automatically start the download or an indication has been received to start the download, then the global software marketplace mechanism begins the download (step 808) and presents a status of the download process to a user (step 810). During the download, the global software marketplace mechanism determines whether the download process has completed (step 812). If at step 812 the global software marketplace mechanism determines that the download process has not completed, then the global software marketplace mechanism determines whether a request has been received to suspend the download process (step 814). If at step 814 the global software marketplace mechanism fails to receive a request to suspend the download process, then the operation returns to step 812. If at step 814 the global software marketplace mechanism receives a request to suspend the download process, then the global software marketplace mechanism suspends the download process (step 816). Then the global software marketplace mechanism determines whether a request is received to resume the download process (step 818). If at step 818 the global software marketplace mechanism fails to receive a request to resume the download process, then the operation returns to step 818. If at step 818 the global software marketplace mechanism receives a request to resume the download process, then the global software marketplace mechanism resumes the download process (step 820), with the operation returning to step 812. If at step 812 the global software marketplace mechanism determines that the download process has completed, then the global software marketplace mechanism presents the user with results of the download (step 822) and sends an indication to installation management logic to start the install process (step 824), with the operation terminating thereafter.

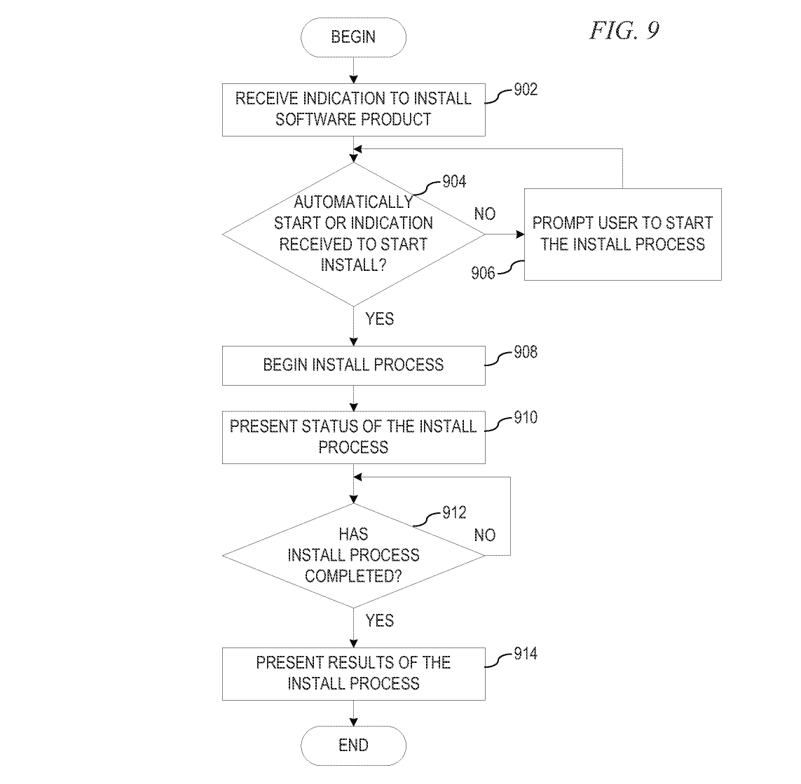

FIG. 9 depicts a flow diagram of the operation performed by installation management logic within a global software marketplace mechanism in either a server system or a client system in accordance with an illustrative embodiment. As the operating begins, the global software marketplace mechanism, executed by a processor, receives an indication to install a software product (step 902). The global software marketplace mechanism determines whether a preference has been set to automatically start the installation or an indication has been received to start the installation (step 904). If at step 904 no preference is set to automatically start the installation or an indication has not been received to start the installation, then global software marketplace mechanism prompts the user to start the installation process (step 906), with the process returning to step 904 thereafter. If at step 904 a preference is set to automatically start the installation or an indication has been received to start the installation, then the global software marketplace mechanism begins the installation (step 908) and presents a status of the installation process to a user (step 910). During the installation, the global software marketplace mechanism determines whether the installation process has completed (step 912). If at step 912 the global software marketplace mechanism determines that the installation process has not completed, then the operation returns to step 912. If at step 912 the global software marketplace mechanism determines that the installation process has completed, then the global software marketplace mechanism presents the user with results of the installation (step 914), with the operation terminating thereafter.

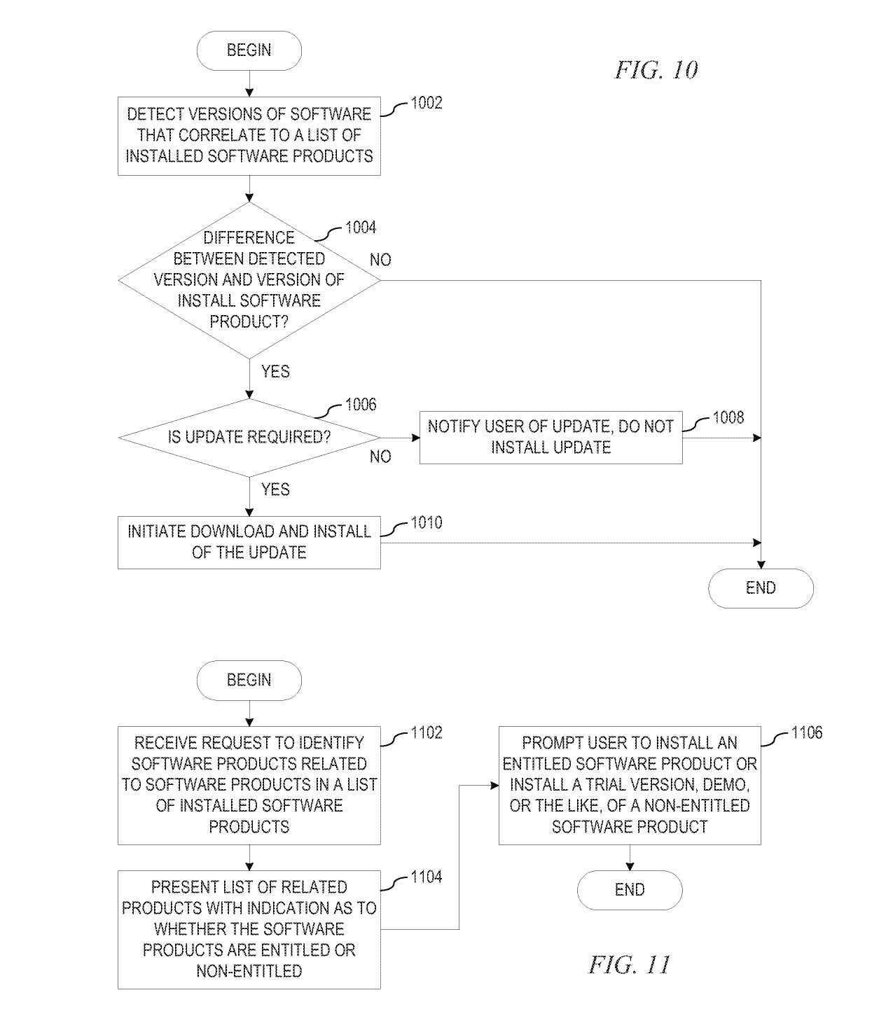

FIG. 10 depicts a flow diagram of the operation performed by upgrade management logic within a global software marketplace mechanism in either a server system or a client system in accordance with an illustrative embodiment. As the operation begins, the global software marketplace mechanism, executed by a processor, searches the software producing entities software download locations to detect versions of software that correlate to a list of installed software products in the repository that are already installed on the computing device (step 1002). The global software marketplace mechanism then determines whether a difference exists between one or more currently installed software product versions in the list of installed software products and its correlating software product version currently residing on the software producing entities software download location (step 1004). If at step 1004 the global software marketplace mechanism determines there is no difference in versions of one or more currently installed software products, then the operation terminates. If at step 1004 the global software marketplace mechanism determines a difference in versions of one or more currently installed software products, then the global software marketplace mechanism identifies whether the update to the one or more currently installed software products is required (step 1006). If at step 1006 the global software marketplace mechanism determines that the update is required, then the global software marketplace mechanism may initiate the download and install the update in the computing system (step 1010), with the operation terminating thereafter. If at step 1006 the global software marketplace mechanism determines that the update is optional, then the global software marketplace mechanism may notify the user of the update but not install the update (step 1008), with the operation terminating thereafter.

FIG. 11 depicts a flow diagram of the operation performed by access requisition logic within a global software marketplace mechanism in either a server system or a client system in accordance with an illustrative embodiment. As the operation begins, the global software marketplace mechanism, executed by a processor, receives a request to identify software products related to software products in a list of installed software products in the repository that are already installed on the computing device (step 1102). The global software marketplace mechanism presents the list of related products with an indication as to whether the software products are entitled products or non-entitled products (step 1104). Entitled software products are software products that are free in cost to a user because the user already has a related product installed on their computing system. Thus, non-entitled software products are software products that are related to one or more software products currently installed on the computing system but are not free to the user. Further, the global software marketplace mechanism may provide prompts to the user that allows the user to install an entitled software product or install a trial version, demo, or the like, of a non-entitled software product (step 1106), with the operation ending thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for unifying the install and upgrade of software products across all software brands and operating system platforms to make consuming software products simple. The mechanisms utilize the concept of private and public catalogs at the same time to provide a complete set of software for user searches. The mechanisms provide the ability for entities that provide software products to install software products utilizing a common interface. The mechanisms make product discovery easy and allows for automatic detection of needed configuration for software product install and configuration. The mechanisms detect the operating system and configuration compatibility in order to ensure that deployed software is always compatible. The mechanisms further provide for software image downloads from multiple locations and across multiple operating system platforms.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for managing the life cycle of software products across multiple platforms comprising:
providing, by a processor on a server, a software product framework for integrating access to information and installation support regarding at least two different software products on at least two different operating system platforms;
registering, by the processor, a first client device for a first version of a software product of the at least two different software products;
registering, by the processor, a second client device for a second version of the software product of the at least two different software products, wherein the first version and the second version are not a same version; and
responsive to receiving a third version of the software product, automatically updating, by the processor, the first version to the third version of the software product of the at least two different software products on the first client device and not automatically updating, by the processor, the second version to the third version of the software product of the at least two different software products on the second client device.

2. The method of claim 1, wherein the software product framework further comprises:
providing, by the processor, support for a repository of a plurality of installation images for each of the at least two different software products.

3. The method of claim 1, wherein the software product framework further comprises:
responsive to receiving a search request for a software product, providing, by the processor, search results from the at least two different software products related to the search request, wherein the search results provide one or more software products from the at least two different software products regardless of the operating system of a computing device that submitted the search request.

4. The method of claim 1, wherein the software product framework further comprises:
responsive to receiving an upgraded version of a software product in the at least two different software products, sending, by the processor, an upgrade notification to one or more clients registered with the server.

5. The method of claim 1, wherein the software product framework further comprises:
responsive to a selection of a product from the at least two different software products by a user of a client device thereby forming a selected software product, verifying, by the processor, compatibility of the selected software product to the operating system of the client device.

6. The method of claim 5, wherein the software product framework further comprises:
verifying, by the processor, compatibility of the selected software product to the configuration of the client device.

7. The method of claim 1, wherein the software product framework further comprises:
identifying, by the processor, one or more software products of the at least two different software products related to a software product already installed on a client device to which the user of the client device is entitled to utilize without having to purchase the one or more software products.

8. The method of claim 1, wherein the software product framework further comprises:
identifying, by the processor, one or more recommended software products based on at least one of a software product already installed on a client device or a software product being searched for.

9. A computer program product comprising a computer readable storage medium having a computer readable program stored therein, wherein the computer readable program, when executed on a computing device, causes the computing device to:
provide a software product framework for integrating access to information and installation support regarding at least two different software products on at least two different operating system platforms;
register a first client device for a first version of a software product of the at least two different software products;
register a second client device for a second version of the software product of the at least two different software products, wherein the first version and the second version are not a same version; and
responsive to receiving a third version of the software product, automatically update the first version to the third version of the software product of the at least two different software products on the first client device and not automatically updating, by the processor, the second version to the third version of the software product of the at least two different software products on the second client device.

10. The computer program product of claim 9, wherein the computer readable program further causes the computing device to:
provide support for a repository of a plurality of installation images for each of the at least two different software products.

11. The computer program product of claim 9, wherein the computer readable program further causes the computing device to:
responsive to receiving a search request for a software product, provide search results from the at least two different software products related to the search request, wherein the search results provide one or more software products from the at least two different software products regardless of the operating system of a computing device that submitted the search request.

12. The computer program product of claim 9, wherein the computer readable program further causes the computing device to:
responsive to receiving art upgraded version of a software product in the at least two different software products, send an upgrade notification to one or more clients registered with the server.

13. The computer program product of claim 9, wherein the computer readable program further causes the computing device to:
responsive to a selection of a product from the at least two different software products by a user of a client device thereby forming a selected software product, verify compatibility of the selected software product to the operating system of the client device; and
verify compatibility of the selected software product to the configuration of the client device.

14. The computer program product of claim 9, wherein the computer readable program further causes the computing device to:
identify one or more software products of the at least two different software products related to a software product already installed on a client device to which the user of the client device is entitled to utilize without having to purchase the one or more software products.

15. An apparatus, comprising:
a processor; and
a memory coupled to the processor, wherein the memory comprises instructions which, when executed by the processor, cause the processor to:
provide a software product framework for integrating access to information and installation support regarding at least two different software products on at least two different operating system platforms;
register a first client device for a first version of a software product of the at least two different software products;
register a second client device for a second version of the software product of the at least two different software products, wherein the first version and the second version are not a same version; and
responsive to receiving a third version of the software product, automatically update the first version to the third version of the software product of the at least two different software products on the first client device and not automatically updating, by the processor, the second version to the third version of the software product of the at least two different software products on the second client device.

16. The apparatus of claim 15, wherein the instructions further cause the processor to:
provide support for a repository of a plurality of installation images for each of the at least two different software products.

17. The apparatus of claim 15, wherein the instructions further cause the processor to:
responsive to receiving a search request for a software product, provide search results from the at least two different software products related to the search request, wherein the search results provide one or more software products from the at least two different software products regardless of the operating system of a computing device that submitted the search request.

18. The apparatus of claim 15, wherein the instructions further cause the processor to:
responsive to receiving an upgraded version of a software product in the at least two different software products, send an upgrade notification to one or more clients registered with the server.

19. The apparatus of claim 15, wherein the instructions further cause the processor to:
responsive to a selection of a product from the at least two different software products by a user of a client device thereby forming a selected software product, verify compatibility of the selected software product to the operating system of the client device; and
verify compatibility of the selected software product to the configuration of the client device.

20. The apparatus of claim 15, wherein the instructions further cause the processor to:
identify one or more software products of the at least two different software products related to a software product already installed on a client device to which the user of the client device is entitled to utilize without having to purchase the one or more software products.
